(19) United States
(12) Patent Application Publication
(10) Pub. No.: US 2008/0080361 A1
(43) Pub. Date: Apr. 3, 2008

(54) Optical Recording Medium

(76) Inventor: Hiroshi Kawai, Kanagawa (JP)

Correspondence Address: TAIYO CORPORATION, 401 HOLLAND LANE, #407, ALEXANDRIA, VA, 22314, US

(21) Appl. No.: 11/632,767

(22) PCT Filed: Jul. 21, 2005
(86) PCT No.: PCT/JP05/13781

§ 371 Date: Jan. 18, 2007

(30) Foreign Application Priority Data
Jul. 23, 2004 (JP) 2004-216228

(51) Int. Cl. G11B 7/24

(52) U.S. Cl. 369/275.1

(57) ABSTRACT

The invention provides an optical recording medium capable of stably forming an image with drawing accuracy. The optical recording medium of the invention comprises a first substrate and a second substrate adhered to each other, and each substrate has a wobble thereon. The first substrate has a wobble amplitude ratio (A) which is higher than a wobble amplitude (B) of the second substrate.

The invention is related to an optical recording medium capable of recording and reproducing information by laser light. The optical recording medium is also capable of forming an image by laser light.

### BACKGROUND ART

In the field of optical recording media such as DVD-R, an optical disc has been put to practical use which has an ink-receiving layer (printing layer) disposed on the label side (the side opposite to the side to be irradiated with laser light at recording or reproducing). Users can print a photograph or a picture on the printing layer by using an inkjet printer or the like.

The system for printing an image by an inkjet printer or the like has been developing steadily, and the image quality has become superior. On the other hand, it is costly to newly prepare an inkjet printer or the like for forming an image. Further, it is troublesome to transfer an optical recording medium to an inkjet printer or the like for image formation after recording of information on the optical recording medium. Particularly, it takes a lot of trouble to record information on a plurality of optical recording media, and then to form images on the optical recording media.

To lighten the burden, an image forming apparatus and an image forming method have been proposed (for example in Japanese Patent Application Laid-Open (JP-A) No. 2004-005848, the disclosure of which is incorporated herein by reference) which can record a high-contrast ratio image on an optical disc, in addition to information recording on the recording surface of the optical disc. The image forming apparatus has functions of forming an image on the label side of the optical information medium and controlling the positioning in the direction of the radius of the disc by a stepping motor without using tracking systems. Since the image forming apparatus records an image without using tracking systems, the accuracy and stability of the image recording are not secured, whereby information cannot be recorded on the region on which the image has been formed.

### DISCLOSURE OF INVENTION

The invention provides an optical recording medium. The optical recording medium comprises a first substrate and a second substrate which are adhered to each other. The first and second substrates each have a wobble. The amplitude ratio (A) of the wobble formed on the first substrate is larger than the amplitude ratio (B) of the wobble formed on the second substrate.

The ratio of the wobble amplitude ratio (A) to the wobble amplitude ratio (B) is preferably 1.2 or higher. The first substrate preferably has an image-recording layer capable of forming a visible image, on the side of the first substrate which side is to be adhered to the second substrate. The second substrate preferably has an information-recording layer capable of recording and reproducing information by an optical method, on the side of the second substrate which side is to be adhered to the first substrate.

### BEST MODE FOR CARRYING OUT THE INVENTION

The optical recording medium of the invention comprises two substrates (a first substrate and a second substrate) which are adhered to each other and which each have a wobble.

The wobble may be, for example, a winding of the groove with a constant amplitude and spatial frequency. The wobble is provided on the substrate so as to provide a signal for controlling a spindle motor or so as to provide a gate signal for detecting a land pre-pit.

In the invention, the amplitude ratio (A) of the wobble formed on the first substrate is larger than the amplitude ratio (B) of the wobble formed on the second substrate. As described later, recording for separate purposes can be conducted because of the difference in amplitude ratio between the wobble on the first substrate and the wobble on the second substrates.

In an embodiment, an image-recording layer capable of forming a visible image is provided on the side (to which the second substrate is adhered) of the first substrate having a larger wobble amplitude ratio and an information-recording layer capable of optically recording and reproducing information is provided on the side (to which the first substrate is adhered) of the second substrate having a smaller wobble amplitude ratio.

In general, a larger wobble amplitude is preferable from the controllability of the rotation. However, an excessively high wobble amplitude ratio is likely to cause errors in the case of an information-recording layer.

On the other hand, the image-recording layer is satisfactory if the image is observable with the naked eye. Accordingly, it is not necessary to pay attention to the occurrence of errors which is an big issue in the case of the information-recording layer. Therefore, the substrate (the first substrate) on which an image-recording layer is to be provided may have a higher wobble amplitude ratio than the substrate (the second substrate) on which an information-recording layer is to be provided.

The ratio of the wobble amplitude ratio (A) to the wobble amplitude ratio (B) is preferably 1.2 or higher. When the wobble amplitude ratio (A) is at least 1.2 times higher than the wobble amplitude ratio (B), the recording on the image-recording layer can be conducted stably while suppressing the occurrence of errors in the information-recording layer. The ratio of the wobble amplitude ratio (A) to the wobble amplitude ratio (B) is more preferably 1.3 to 2.5, still more preferably 1.5 to 2.3.

In this specification, the term “wobble amplitude ratio” (the amplitude ratio of wobble) refers to the ratio of the average wobble amplitude taken over one circuit to the average TE (Tracking Error) signal amplitude taken over one circuit. In other words, the wobble amplitude ratio on a disc (substrate) is expressed by the following expression:

Wobble amplitude ratio =[wobble amplitude (average of P-P (peak-to-peak) value taken over the course of one circuit on the disc)]/[TE signal amplitude (average of P-P (peak-to-peak) value taken over the course of one circuit on the disc)]

The ratio of the wobble amplitude ratio (A) to the wobble amplitude ratio (B) is preferably in the above-described range. The respective wobble amplitude ratios (A) and (B) are preferably in the following range.

The wobble amplitude ratio (A) is preferably 0.09 to 0.40, more preferably 0.12 to 0.24. The wobble amplitude ratio (B) is preferably 0.06 to 0.25, more preferably 0.08 to 0.18.

The respective amplitude ratios (A) and (B) can be adjusted by controlling the wobble shape (the amplitude of the meandering groove) during the formation of the substrate.

The type of the optical recording medium of the invention is not particularly limited as long as the optical recording medium has the image-recording layer and the information-recording layer. The optical recording medium may be a write-once optical recording medium or a rewritable optical recording medium. The optical recording medium may be an optical recording medium of a phase change type, a magnetooptical type, or a dye type. The optical recording medium is preferably a write-once dye-type optical recording medium in consideration of capability of forming clear pits and producibility at a low cost.

Examples of the layer constitution of the optical recording medium of the invention are described below:
(1) In the first constitution, an information-recording layer, a reflection layer, and an adhesive layer are sequentially provided on a second substrate in this order, and a first substrate having an image-recording layer is adhered to the adhesive layer.
(2) In the second constitution, an information-recording layer, a reflection layer, a protective layer, and an adhesive layer are sequentially provided on a second substrate in this order, and a first substrate having an image-recording layer is adhered to the adhesive layer.
(3) In the third constitution, an information-recording layer, a reflection layer, a protective layer, an adhesive layer, and a protective layer are sequentially provided on a second substrate in this order, and a first substrate having an image-recording layer is adhered to the protective layer.
(4) In the fourth constitution, an information-recording layer, a reflection layer, a protective layer, an adhesive layer, a protective layer, and a reflection layer are sequentially provided on a second substrate in this order, and a first substrate having an image-recording layer is adhered to the reflection layer.
(5) In the fifth constitution, an information-recording layer, a reflection layer, an adhesive layer, and a reflection layer are sequentially provided on a second substrate in this order, and a first substrate having an image-recording layer is adhered to the reflection layer.
(6) In the sixth constitution, an information-recording layer, a reflection layer, and a protective layer are sequentially provided on a second substrate in this order, and an image-recording layer, a reflection layer, and a protective layer are provided on a first substrate in this order, and the protective layers of on the two substrates are attached to each other via an adhesive layer disposed between the protective layers.

The above-described first to sixth constitutions are examples and the layer constitution is not limited to the first to sixth constitutions. For example, the layer constitution may be a layer constitution obtained by changing the order of the layers of any of the above-described constitutions. The layer constitution may be a layer constitution obtained by replacing some of the layers of any of the above-described constitutions by other layer(s). The layer constitution may be a layer constitution obtained by omitting some of the layers of any of the above-described constitutions while retaining the information-recording layer and the image-recording layer. Each of the layers of the optical recording medium may be comprised of a single layer or two or more layers.

In the following, the substrates and the respective layers are described. In the following explanation, the first and second substrates are collectively referred to as “substrate” in some cases. Japanese Patent Application No. 2004-216228 is incorporated herein by reference. Information-Recording Layer and Image-Recording Layer When the optical recording medium of the invention is a dye-type optical recording medium, the information-recording layer and the image-recording layer (hereinafter collectively referred to as “recording layer” in some cases) each include a dye as a recording substance.

The dye may be, for example, a cyanine dye, an oxonol dye, a metal complex dye, an azo dye, or a phthalocyanine dye.

The dyes disclosed in the following documents are also usable in the invention: JP-A Nos. 4-74690, 8-127174, 11-53758, 11-334204, 11-334205, 11-334206, 11-334207, 2000-43423, 2000-108513, and 2000-158818, the disclosures of which are incorporated herein by reference. WO 2006/009302 PCT/JP2005/013781

The recording substance is not limited to dyes. In an embodiment, the recording substance is an organic compound such as a triazole compound, a triazine compound, a cyanine compound, a merocyanine compounds, an aminobutadiene compound, a phthalocyanine compound, a cinnamic acid compound, a viologen compound, an azo compound, an oxonolbenzoxazole compound, or a benztriazole compound. Among these compounds, a cyanine compound, an aminobutadiene compound, a benztriazole compound, and a phthalocyanine compound are preferable.

The recording layer may be formed by a deposition method or a coating method, preferably by a coating method.

In an example of the coating method, a dye and optional additives such as a quencher and a binder are dissolved in a solvent to form a coating liquid, and the coating liquid is applied to the surface of the substrate by a spin-coating or a dip-coating to form a film, and the film is dried to form a recording layer. In this exemplary coating method, generally, the concentration of the recording substance in the coating liquid is preferably 0.01 to 15 % by mass, more preferably 0.1 to 10 % by mass, still more preferably 0.5 to 5 % by mass, further more preferably 0.5 to 3 % by mass.

The solvent of the coating liquid may be selected from: esters such as butyl acetate, ethyl lactate, and cellosolve acetate; ketones such as methyl ethyl ketone, cyclohexanone, WO 2006/009302 PCT/JP2005/013781 and methyl isobutyl ketone; chlorinated hydrocarbons such as dichloromethane, 1,2-dichloroethane, and chloroform; amides such as dimethylformamide; hydrocarbons such as methylcyclohexane; ethers such as dibutyl ether, diethyl ether, tetrahydrofuran, and dioxane; alcohols such as ethanol, n-propanol, isopropanol, n-butanol, and diacetone alcohol; fluorine-based solvents such as 2,2,3,3-tetrafluoropropanol; and glycol ethers such as ethylene glycol monomethyl ether, ethylene glycol monoethyl ether, and propylene glycol monomethyl ether.

The solvent may be selected in consideration of the solubility of the dye to be used in the solvent, and only a single solvent may be used or two or more solvents may be used. The coating liquid may further include various additives such as antioxidants, UV absorbers, plasticizers, and lubricants, in accordance with the purpose.

When a binder is used, the binder may be selected from: natural organic high-molecular substances such as gelatin, cellulose derivatives, dextran, rosin, and rubber; hydrocarbon resins such as polyethylene, polypropylene, polystyrene, and polyisobutylene; vinyl resins such as polyvinyl chloride, polyvinylidene chloride, and polyvinyl chloride-polyvinyl acetate copolymers; acrylic resins such as polymethyl acrylate and polymetyl methacrylate; and synthetic organic high-molecular compounds such as polyvinyl alcohol, chlorinated polyethylene, epoxy resins, butyral resins, rubber derivatives, initial condensates of thermosetting resins such as phenol-formaldehyde resins.

When a binder is used as a component of the recording layer material, the mass ratio of the amount of the binder to the amount of the dye is preferably in the range of 0.01 to 50, more preferably in the range of 0.1 to 5.

The coating liquid may be coated by a spray coating method, a spin coating method, a dip coating method, a roll coating method, a blade coating method, a doctor roll method, or a screen printing method. The recording layer may be comprised of a single layer or two or more layers. The thickness of the recording layer is generally in the range of 10 to 500 nm, preferably in the range of 15 to 300 nm, more preferably in the range of 20 to 150 nm.

An antifading agent may be included in the recording layer so as to improve the light resistance of the recording layer, and the antifading agent may be selected from various antifading agents. The antifading agent is generally a singlet-oxygen quencher. The singlet-oxygen quencher may be selected from singlet-oxygen quenchers disclosed in known published documents such as patent specifications. Examples thereof include the singlet-oxygen quenchers disclosed in JP-A No. 58-175693, 59-31194, 60-18387, 60-19586, 60-19587, 60-35054, 60-36190, 60-36191, 60-44554, 60-44555, 60-44389, 60-44390, 60-54892, 60-47069, and 4-25492, and Japanese Patent Publication (JP-B) Nos. 1-38680 and 6-26028, German Patent No. 350399, and Nihon Kagakukaishi (1992 October) p. 1141, the disclosures of which are incorporated herein by reference.

The amount of the antifading agent to be used such as a singlet-oxygen quencher is generally 0.1 to 50 % by mass based on the amount of the dye, preferably 0.5 to 45 % by mass, more preferably 3 to 40% by mass, still more preferably 5 to 25 % by mass based on the amount of the dye.

When the recording layer is a phase change recording layer, examples of the material of the recording layer include Sb-Te alloys, Ge—Sb—Te alloys, Pd—Ge—Sb—Te alloys, Nb—Ge—Sb—Te alloys, Pd—Nb—Ge—Sb—Te alloys, Pt—Ge—Sb—Te alloys, Co—Ge—Sb—Te alloys, In—Sb—Te alloys, Ag—In—Sb—Te alloys, Ag—V—In—Sb—Te alloys, and Ag—Ge—In—Sb—Te alloys. Among the substances, Ge—Sb—Te alloys and Ag—In—Sb—Te alloys are preferable since the alloys enable rewriting for many times.

The thickness of the phase change recording layer is preferably 10 to 50 nm, more preferably 15 to 30 nm.

The phase change recording layer can be formed by a sputtering method or a vapor-phase thin film deposition method such as a vacuum deposition method.

A visible image (visible information) desired by the user is recorded on the image-recording layer, and the image may be a character, a figure, or a picture. The term “visible image” refers to an image which is visually recognizable. The scope of the term “visible image” includes any visually recognizable information such as a character, a character string, a picture, and a figure. The visually recognizable information may be the disc title, content information, thumbnail of the content, a related picture, a design picture, information on the copyright, the recording date, the recording method, or the recording format.

On the other hand, the information to be recorded on the information-recording layer is such information as to be recorded optically on the recording layer of a general DVD-R or the like.

In the optical recording medium of the invention, the component of the information-recording layer (a dye or a phase change recording substance) may be the same as or different from the component (recording substance) of the image-recording layer. The components in the respective layers are preferably different since the characteristics desired for the information-recording layer is different from the characteristics desired for the image-recording layer. Specifically, the component of the information-recording layer is preferably excellent in the recording and reproducing characteristics, and the component of the image-recording layer is preferably such a substance that the recorded image has a high contrast. When a dye is used in the image-recording layer, the dye is preferably, among the dyes described above, a cyanine dye, a phthalocyanine dye, an azo dye, an azo-metal complex, or an oxonol dye, from the viewpoint of improving the contrast of the recorded image.

In an embodiment, one of the information-recording layer and the image-recording layer is of a phase change type, and the other layer is of a dye type. In this embodiment, the image-recording layer is preferably a phase change type image-recording layer, and the information-recording layer is preferably a dye-type information-recording layer. Substrate (First Substrate and Second Substrate) The wobble formed on the substrate is as described above.

The substrate of the optical recording medium of the invention may be arbitrarily selected from various materials used as substrates of conventional optical recording media.

The substrate material may be, for example, glass, polycarbonate, an acrylic resin such as polymethyl methacrylate, a vinyl-chloride-based resin such as polyvinyl chloride or a vinyl chloride copolymer, an epoxy resin, amorphous polyolefin, or polyester. Two or more of the above materials may be used together, if desired.

The material may be used as a film-like substrate or a rigid substrate. Among the above materials, polycarbonate is preferable from the viewpoints of the moisture resistance, the dimensional stability, the price, and the like.

The thickness of the substrate is preferably 0.1 to 1.2 mm, more preferably 0.2 to 1.1 mm, still more preferably 0.4 to 0.8 mm.

When the optical recording medium of the invention is a DVD-R or a DVD-RW, the track pitch of the pregroove is preferably 300 to 900 nm, more preferably 350 to 850 nm, still more preferably 400 to 800 nm.

The depth of the pregroove is preferably 100 to 160 nm, more preferably 120 to 150 nm, still more preferably 130 to 140 nm.

The half-width of the pregroove is preferably 200 to 400 nm, more preferably 230 to 380 nm, still more preferably 250 to 350 nm.

When the optical recording medium of the invention is a so-called HD-DVD, it is preferable to use a substrate on which a groove having a narrower track pitch than the above-described DVD-R or the like is formed, for the purpose of achieving a higher recording density. In this case, the track pitch of the groove is preferably 200 to 400 nm, more preferably 250 to 350 nm. The depth of the groove is preferably 20 to 150 nm, more preferably 50 to 100 nm.

The half-width of the groove is preferably 50 to 250 nm, more preferably 100 to 200 nm. The angle of inclination of the groove is preferably 20 to 80 °, more preferably 30 to 70°.

The side of the substrate on which the recording layer is to be provided (the side having the groove) may be provided with an undercoat layer for the purposes of improving the planarity and the adhesion force, and preventing degradation of the recording layer.

Examples of the material of the undercoat layer include: high-molecular substances such as polymethyl methacrylate, acrylic acid-methacrylic acid copolymers, styrene-maleic anhydride copolymers, polyvinyl alcohol, N-methylol acrylamide, styrene-vinyltoluene copolymers, chlorosulfonated polyethylene, nitrocellulose, polyvinyl chloride, chlorinated polyolefin, polyester, polyimide, vinyl acetate-vinyl chloride copolymers, ethylene-vinyl acetate copolymers, polyethylene, polypropylene, and polycarbonate; and surface modifiers such as silane coupling agents. The undercoat layer may be formed by: dissolving or dispersing the material for the undercoat layer in an appropriate solvent to form a coating liquid, and then coating the substrate surface with the coating liquid by a coating method such as spin coating, dip coating, or extrusion coating.

The thickness of the undercoat layer is generally 0.005 to 20 μm, more preferably 0.01 to 10 μm.

### Reflection Layer

A reflection layer is provided adjacent to the recording layer in some cases for the purpose of improving the reflectance at the time of reproduction. The light-reflecting substance, which is the material of the reflection layer, is a substance having a high laser-light reflectance. Examples thereof include metals and semimetals such as Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ga, In, Si, Ge, Te, Pb, Po, Sn, and Bi, and stainless steel. Only a single light-reflecting substance may be used, or a combination of two or more light-reflecting substances may be used, or an alloy of two or more light-reflecting substances may be used. The light-reflecting substance is preferably Cr, Ni, Pt, Cu, Ag, Au, Al, or stainless steel, more preferably metallic Au, metallic Ag, metallic Al or an alloy thereof, still more preferably metallic Ag, metallic Al, or an alloy thereof. The reflection layer may be formed on the substrate or on the recording layer, for example by depositing, sputtering, or ion-plating a light-reflecting substance. The thickness of the light reflection layer is generally 10 to 300 nm, preferably 50 to 200 nm.

### Adhesive Layer

The adhesive layer is a layer provided for improving the adhesion between the substrates.

The material constituting the adhesive layer is preferably a photosetting resin, and the photosetting resin is preferably a photosetting resin having a small cure shrinkage from the viewpoint of preventing curl of the disc. The photosetting resin may be, for example, a UV-setting resin (UV setting adhesive) such as SD-640 or SD-347 manufactured by Dainippon Ink and Chemicals Incorporated. The thickness of the adhesive layer is preferably 1 to 1000 μm so as to impart flexibility, more preferably 5 to 500 μm, still more preferably 10 to 100 μm.

### Protective Layer

A protective layer is provided in some cases, in order to protect the reflection layer, the recording layer, or the like physically and chemically.

Examples of the material used in the protective layer include inorganic substances such as ZnS, ZnS-SiO2, SiO, SiO₂, MgF2, SnO2, and Si₃N₄; and organic substances such as thermoplastic resins, thermosetting resins, and UV-setting resins. The protective layer may be formed by: preparing a film by an extrusion-molding of a plastic, and laminating the film on the reflection layer via an intervening adhesive. As an alternative, the protective layer may be formed by a method such as vacuum deposition, sputtering, or coating.

When the protective layer material is a thermoplastic resin or a thermosetting resin, the protective layer may be formed by: dissolving the thermoplastic or thermosetting resin in an appropriate solvent to form a coating liquid, and then coating the coating liquid followed by drying. When the protective layer material is a UV-setting resin, the protective layer may be formed by: dissolving the UV-setting resin in an appropriate solvent to form a coating liquid, and then coating the coating liquid, and then irradiating the coating film with UV light to cure the film. In the above methods, the coating liquids may further include various additives such as antistatic agents, antioxidants, and UV absorbers, in accordance with the purpose. The thickness of the protective layer is preferably 0.1 μm to 1 mm.

### Recording Method

In the method of recording on the optical recording medium of the invention, the recording of the image on the image-recording layer and the recording of the information on the information-recording layer may be conducted by a single optical disc drive (recording instrument) capable of recording on both of the recording layers, or may be conducted separately by a recording instrument exclusively for recording on the image-recording layer and a recording instrument exclusively for recording on the information-recording layer, respectively. In both cases, after the recording on one of the image-recording layer and the information-recording layer is conducted, the optical recording medium may be turned over so as to enable the recording on the other recording layer. Examples of the optical disc drive capable of recording a visible image on the image-recording layer are disclosed, for example, in JP-A Nos. 2003-203348 and 2003-242750, the disclosures of which are incorporated herein by reference.

The recording of a visible image on the image-recording layer is conducted by: moving the optical recording medium or the laser pickup or both such that the optical recording medium and the laser pickup move relative to each other and that the relative movement is in the direction of a radius on the plane of the optical recording medium, while irradiating the image-recording layer with a laser light in synchronization with the relative movement, the laser light being modulated in accordance with the image data (such as a character or a picture) to be recorded. Such a constitution is described, for example, in JP-A No. 2002-203321, the disclosure of which is incorporated herein by reference.

The laser light for recording may be a semiconductor laser having an oscillation wavelength in the range of 350 to 850 nm.

When the information-recording layer is a phase change information-recording layer, the information-recording layer comprises a substance such as described above, and the phase transition between the crystal phase and the amorphous phase can be repeated by irradiation with laser light.

Upon recording of information, the phase change recording layer is irradiated with a focused laser light pulse for a short time to melt the phase change recording layer partially. The melted portion is rapidly cooled by heat diffusion to solidify, thereby forming a recording mark in the amorphous state. Upon erasing the information, the recording mark portion is irradiated with laser light to be heated to a temperature which is in the range of from the crystallization temperature of the recording layer to the melting point of the recording layer inclusive, and then slowly cooled to crystallize the recording mark in the amorphous state, thereby returning the recording mark portion to the initial unrecorded state. cl EXAMPLES

The present invention is described in more detail with reference to Examples. However, the invention is not limited to the Examples.

### Example 1

### Production of Optical Recording Medium

The optical recording medium of this Example is a DVD-R type optical recording medium comprising two substrates attached to each other. In the following, the method of producing the optical recording medium is described.

A second substrate was formed from a polycarbonate resin by injection molding. The second substrate had a thickness of 0.6mm and a diameter of 120 mm, and had a spiral (helical) groove. The spiral groove had a depth of 130 nm, a width of 300 nm, a track pitch of 0.74 μm, and a wobble amplitude ratio (B) of 0.16. 0.75 g of a dye A shown below and 0.50 g of a dye B shown below were dissolved in 100 ml of 2,2,3,3-tetrafluoro-1-propanol to form a coating liquid, and the substrate surface having the groove was coated with the coating liquid by spin coating to form an information-recording layer. Then, silver was sputtered to form a reflection layer having a thickness of 120 nm on the information-recording layer. Then, the reflection layer was coated with a UV-setting resin (SD318 manufactured by Dainippon Ink and Chemicals Incorporated.) by spin coating, and then the UV-setting resin was irradiated with UV light to cure, thereby forming a protective layer having a thickness of 10 μm.

Through the processes described above, a laminate (2) was obtained which comprised the second substrate and the information-recording layer, the reflection layer, and the protective layer disposed in this order on the second substrate.

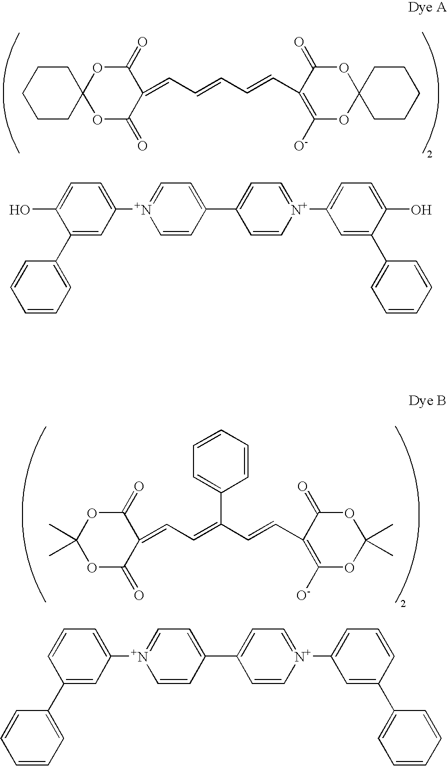

A first substrate was formed from a polycarbonate resin by injection molding. The first substrate had a thickness of 0.6mm and a diameter of 120 mm, and had a spiral (helical) groove. The spiral groove had a depth of 130 nm, a width of 300 nm, a track pitch of 0.74 μm, and a wobble amplitude ratio (A) of 0.24. Subsequently, 0.75 g of the dye A and 0.50 g of a dye C shown below were dissolved in 100 ml of 2,2,3,3-tetrafluoro-1-propanol to form a coating liquid. The surface of the first substrate having the groove was coated with the coating liquid by spin coating to form an image-recording layer. Then, silver was sputtered to form a reflection layer having a thickness of 120 nm on the image-recording layer. Subsequently, the reflection layer was coated with a UV-setting resin (SD318 manufactured by Dainippon Ink and Chemicals Incorporated.) by spin coating, then the UV-setting resin was irradiated with UV light to cure, thereby forming a protective layer having a thickness of 10 μm. Through the processes described above, a laminate (1) was obtained which comprised the first substrate and the image-recording layer, the reflection layer, and the protective layer disposed in this order on the first substrate.

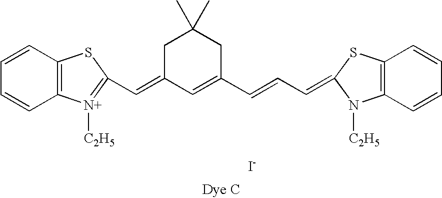

Subsequently, the laminate (1) and the laminate (2) were adhered to each other to form an optical recording material through the following processes.

A slow-acting cation polymerization type adhesive (SDK7000 manufactured by Sony Chemicals Corporation) was printed on the protective layers of the respective laminates by screen printing. The mesh size of the printing plate used for the screen printing was 300 mesh. Then, the printed adhesive was irradiated with UV rays, using a metal halide lamp. Immediately after the irradiation, the laminate (1) and the laminate (2) were adhered to each other such that the protective layers of the laminates (1) and (2) faced each other. Then, pressure was applied to both sides, and the adhered laminates were left in this state for 5 minutes to form an optical recording medium of

### Example 1

The wobble amplitude ratios (A) and (B) were each obtained by normalizing the wobble amplitude by the TE signal amplitude, using a disc drive instrument (DDU1OOO manufactured by Pulsetec Indurstrial Co., Ltd.).

### Examples 2 and 3 and Comparative Example 1

### (Production of Optical Recording Medium)

Optical recording media were each produced in the same manner as in Example 1, except that the shape of the wobble (the amplitude of the meandering groove) formed on the first substrate was adjusted by changing the stamper used for the injection molding of the first substrate such that the ratio of the wobble amplitude ratio (A) to the wobble amplitude ratio (B) were changed to the value shown in Table 1.

The amplitude ratios (A) of the wobbles formed on the first substrates in Example 2, Example 3, and Comparative Example 1 were 1.2, 2.4, and 1.0, respectively.

### (Evaluation)

The firmware of a commercially available DVD±R drive was modified, so that a drive was obtained which could read the LPP (Land PrePit) information on the image-recording side and could form an image.

Using the modified drive instrument, image recording was conducted on the image-recording layers of the optical recording media of Examples 1 to 3 and Comparative Example 1. It was confirmed in each Example whether the image was accurately recorded on the recording layer or whether the image recording was inaccurate. The results are shown in Table 1 below.

The term “inaccurate recording” refers to the state in which image shift or blur occurs in the formed image owing to irregular rotating velocity or the state in which the image recording stops before completion.

TABLE 1

| | Ratio of Wobble Amplitude | |
|---|---|---|
| | Ratio (A) to Wobble | Inaccurate Image |
| | Amplitude Ratio (B) | Recording |
| Example 1 | 1.5 | Not Occurred |
| Example 2 | 1.2 | Not Occurred |
| Example 3 | 2.4 | Not Occurred |
| Comparative | 1.0 | Occurred |
| Example 1 | | |

As is shown in Table 1, inaccurate recording occurred in Comparative Example 1. In contrast, the image quality was excellent in all of Examples 1 to 3 without occurrence of inaccurate recording on the image-recording layer.

As described above, the present invention provides an optical recording medium capable of forming an image stably with a high drawing accuracy. The optical recording medium of the invention is capable of recording and reproducing general optical information, and is also capable of forming a visible image thereon.

1. An optical recording medium comprising a first substrate and a second substrate adhered to each other, wherein the first substrate has an image-recording layer on a side nearer to the second substrate, the second substrate has an information-recording layer on a side nearer to the first substrate, the image-recording layer is capable of forming a visible image, the information-recording layer is capable of recording and reproducing information optically each substrate has a wobble thereon, and a wobble amplitude ratio (A) of the first substrate is higher than a wobble amplitude ratio (B) of the second substrate.

2. The optical recording medium according to claim 1, wherein the ratio of the wobble amplitude ratio (A) to the wobble amplitude ratio (B) is 1.2 or higher.

3. The optical recording medium according to claim 1, wherein the ratio of the wobble amplitude ratio (A) to the wobble amplitude ratio (B) is 1.3 to 2.5.

4. (canceled)

5. (canceled)

6. (canceled)

7. The optical recording medium according to claim 41, wherein the wobble amplitude ratio (A) is 0.09 to 0.40.

8. The optical recording medium according to claim 41, wherein the wobble amplitude ratio (B) is 0.06 to 0.25.
